(19) United States
(12) Patent Application Publication
(10) Pub. No.: US 2017/0086080 A1
(43) Pub. Date: Mar. 23, 2017

(54) System and Method for Fast Beamforming Setup

(71) Applicant: Huawei Technologies Co., Ltd., Shenzhen (CN)

(72) Inventors: Sheng Sun, Kanata (CA); Yan Xin, Kanata (CA)

(21) Appl. No.: 14/858,767

(22) Filed: Sep. 18, 2015

(51) Int. Cl. H04W 16/28; H04W 72/04; H04W 76/02; H04L 29/08

(52) U.S. Cl. CPC H04W 16/28; H04L 67/104; H04W 72/046; H04W 76/023; H04W 84/12

(57) ABSTRACT

A method for operating a first station adapted for directional peer to peer communications includes obtaining geometry information associated with a second station, and establishing a directional peer-to-peer link with the second station using a first transmission beamformed in accordance with an angle of departure for the second station, wherein the angle of departure is associated with the geometry information.

### TECHNICAL FIELD

The present disclosure relates generally to digital communications, and more particularly to a system and method for fast beamforming setup.

### BACKGROUND

Directional device-to-device communications (also commonly known as directional peer to peer communications), wherein two or more stations communicate directly with one another with appropriate directional antenna configurations without having to communicate through an access point (AP), is a prevalent usage scenario within the 60 GHz band of IEEE 802.11 technical standards compliant communications systems. The IEEE 802.11 working group ad specified a technical standard commonly referred to as IEEE 802.11ad defines a procedure to establish peer to peer discovery and protocol thereof. It has been specified that before beamforming (BF) between individual peer stations, a personal basic service set (PBSS) control point (PCP) and/or AP should complete at least sector level sweep (SLS) BF with respective stations in a beam transmission interval (BTI) or associated beamforming training (A-BFT) period as well as an association procedure.

The peer to peer discovery can be achieved along with BF between the peer stations. Information requests and responses between source and target stations shall be exchanged after the BF. BF between the peer stations repeats the SLS BF procedure similar to what has been done between PCP/AP and a station, thereby introducing additional complexity and further delay compared to PCP/AP to station communications.

### SUMMARY OF THE DISCLOSURE

Example embodiments provide a system and method for fast beamforming setup.

In accordance with an example embodiment, a method for operating a first station adapted for directional peer-to-peer communications is provided. The method includes obtaining, by the first station, geometry information associated with a second station, and establishing, by the first station, a directional peer-to-peer link with the second station using a first transmission beamformed in accordance with an angle of departure for the second station, wherein the angle of departure is associated with the geometry information.

In accordance with another example embodiment, a method for operating a serving device is provided. The method includes providing, by the serving device, first geometry information associated with a first station to a second station responsive to a first request from the second station, providing, by the serving device, second geometry information associated with the second station to the first station responsive to a second request from the first station, and scheduling, by the serving device, resources for directional communications between the first station and the second station.

In accordance with another example embodiment, a first station adapted for directional communications is provided. The initiating station includes a processor, and a computer readable storage medium storing programming for execution by the processor. The programming including instructions to obtain geometry information associated with a second station, and to establish a directional peer-to-peer link with the second station using a first transmission beamformed in accordance with an angle of departure for the second station, wherein the angle of departure is associated with the geometry information.

In accordance with another example embodiment, a serving device adapted for directional communications is provided. The serving device includes a processor, and a computer readable storage medium storing programming for execution by the processor. The programming including instructions to provide first geometry information associated with a first station to a second station responsive to a first request from the second station, to provide second geometry information associated with the second station to the first station responsive to a second request from the first station, and to schedule resources for directional communications between the first station and the second station.

Practice of the foregoing embodiments helps stations to quickly establish beamforming based on estimates of angles. The quick operation helps to reduce complexity and delay.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system according to example embodiments described herein;

FIG. 2A illustrates a flow diagram of example operations occurring in participating in directional communications according to example embodiments described herein;

FIG. 2B illustrates a flow diagram of example operations occurring in passive directional service discovery according to example embodiments described herein;

FIG. 2C illustrates a flow diagram of example operations occurring in active directional service discovery according to example embodiments described herein;

FIG. 2D illustrates a flow diagram of example operations occurring in passive and active directional service discovery according to example embodiments described herein;

FIG. 3 illustrates a portion of a communications system highlighting sectors of a PCP/AP according to example embodiments described herein;

FIG. 4 illustrates a message exchange diagram highlighting messages exchanged during the configuration of directional peer-to-peer communications according to example embodiments described herein;

FIG. 5 illustrates a communications system highlighting geometry information used in the fast BF setup procedure according to example embodiments described herein;

FIG. 6 illustrates a flow diagram of example operations occurring in a station initiating directional communications using a multi-stage fast BF setup procedure according to example embodiments described herein;

FIG. 7 illustrates a flow diagram of example operations occurring in a PCP/AP participating in a multi-stage fast BF setup procedure according to example embodiments described herein;

FIG. 8 illustrates a flow diagram of example operations occurring in a station participating in directional peer-to-peer communications involving a multi-stage fast BF setup procedure according to example embodiments described herein;

FIG. 9 illustrates an example peer-STA IE according to example embodiments described herein;

FIG. 10 illustrates a block diagram of an embodiment processing system for performing methods described herein; and

FIG. 11 illustrates a block diagram of a transceiver adapted to transmit and receive signaling over a telecommunications network according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the embodiments disclosed herein, and do not limit the scope of the disclosure.

One embodiment relates to fast beamforming setup by utilizing auxiliary information from third party. For example, an initiating station obtains geometry information associated with a second station, and establishes a directional peer-to-peer link with the second station using a first transmission beamformed in accordance with an angle of departure for the second station, wherein the angle of departure is associated with the geometry information.

The embodiments will be described with respect to example embodiments in a specific context, namely communications systems that use auxiliary information from a third party to facilitate directional communications. The embodiments may be applied to standards compliant communications systems, such as those that are compliant with Third Generation Partnership Project (3GPP), IEEE 802.11, and the like, technical standards, and non-standards compliant communications systems, that fast beamforming setup to facilitate directional communications.

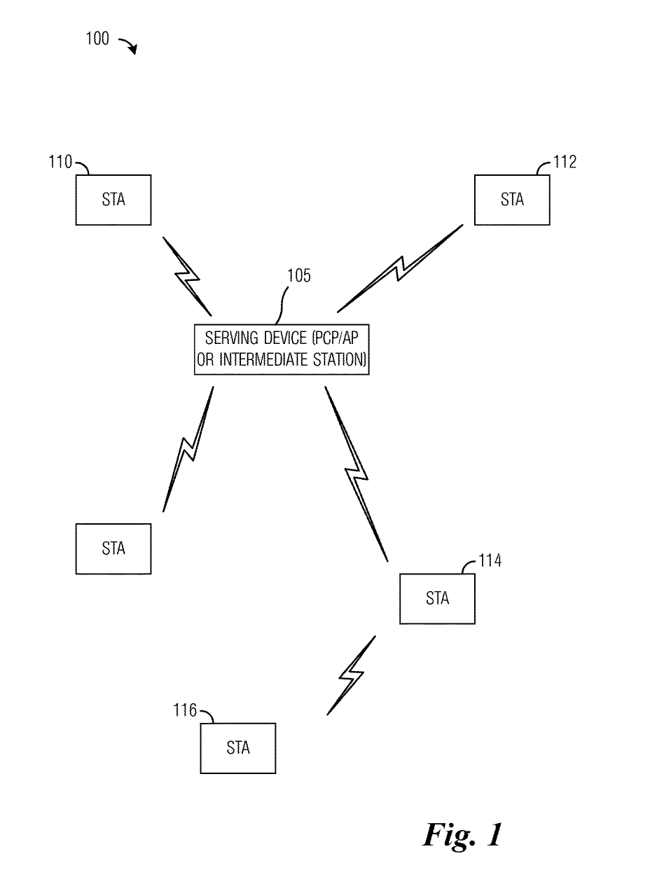

FIG. 1 illustrates an example communications system 100. Communications system 100 includes a serving device (e.g., a PCP/AP or an intermediate station) 105 that serves a plurality of stations, such as stations 110, 112, and 114. A PCP/AP may also be commonly referred to as a base station, a NodeB, an evolved NodeB (eNB), a communications controller, a base terminal station, and the like, while a station may also be commonly referred to as a mobile station, a mobile, a user equipment (UE), a subscriber, a user, a terminal, and so on.

In a first operating mode, communications to and from stations go through serving device 105. In other words, a transmission to a station is initially sent to serving device 105 prior to being sent to the station, while a transmission from a station to a destination is initially sent to serving device 105 before it is sent to the destination. The first operating mode may be referred to as AP controlled communications. In a second operating mode, stations directly communicate with one another without having to go through serving device 105. The second operating mode is often referred to as peer to peer communications. As shown in FIG. 1, station 116 and station 114 are participating in peer-to-peer communications with each other with a directional component, which is hereby referred to herein as directional peer-to-peer communications. Although station 116 and station 114 are participating in directional peer-to-peer communications, the stations may also participate in the AP controlled communications with other stations or services, as well as peer-to-peer communications without directionality.

While it is understood that communications systems may employ multiple serving devices capable of communicating with a number of stations, only one serving device, and a number of stations are illustrated for simplicity.

The 60 GHz spectrum is a promising portion of the electromagnetic spectrum that can handle very high data rates. However, due to high path loss at the elevated frequencies, directional antennas are considered as necessary for operation. The use of directional antennas requires the knowledge of the angles of arrival of surrounding devices in order to properly direct transmissions to the surrounding devices.

As specified in IEEE 802.11ad, before beamforming between individual stations can occur, the serving device completes a SLS BF procedure with the respective stations in a BTI and an A-BFT period, as well as an association procedure with the stations after SLS BF between the serving device and the respective stations. Furthermore, in order to establish directional connectivity, beamforming between peer stations is required, which requires the repeating of the SLS BF procedure. Therefore, there is unnecessary complexity and delay when compared to AP controlled communications.

According to an example embodiment, the unnecessary complexity and delay inherent in directional communications in IEEE 802.11ad is addressed with an optimized fast BF setup system and method. The optimized fast BF setup system and method reduces the complexity and delay associated with the BF procedure as disclosed in the IEEE 802.11ad technical standards.

According to an example embodiment, a multi-stage fast BF system and method is provided to reduce complexity and delay associated with establishing directional communications. The multi-stage approach enables the establishment of the directional connections without suffering high complexity or delay, while still allowing for ability to achieve a high level of performance associated with finely tuned transmission beams. According to an example embodiment, fast BF setup is achieved through the use of the angles of arrival of surrounding devices. The use of the angles of arrivals helps to speed up BF setup. The angles of arrival may be determined (e.g., calculated, estimated, derived, and so on) based on geometry information obtained from the serving device. According to an example embodiment, a fine tuning of the angles of arrival of surrounding devices enables the ability to subsequently improve the performance of the directional communications without placing undue complexity and delay penalties on an initial establishing (setup) of the directional connections. Although the discussion focuses on the use of angles of arrival to help speed up BF setup, the example embodiments presented herein are also operable with angles of departure. Therefore, the discussion of angles of arrival and vice versa should not be construed as being limiting to either the scope or the spirit of the example embodiments.

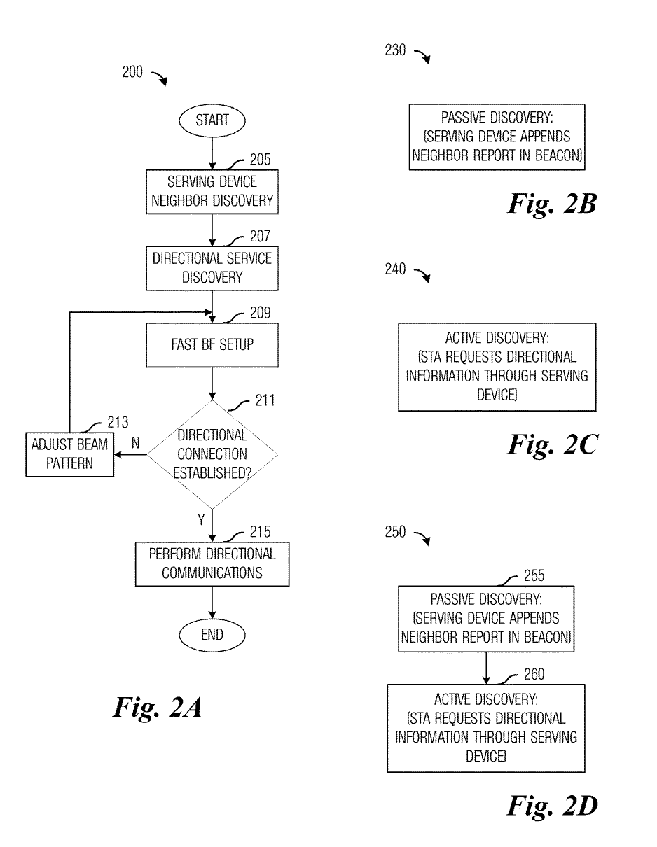

FIG. 2A illustrates a flow diagram of example operations 200 occurring in participating in directional peer-to-peer communications. Operations 200 may be indicative of operations occurring while participating in directional peer-to-peer communications. Operations 200 may be occurring in a station participating in directional peer-to-peer communications.

Operations 200 begin with the station participating in serving device neighbor discovery (block 205). Neighbor discovery may involve the collection of a station's spatial information, such as angle of arrival, distance, and so forth. Neighbor discovery may also include the collection of capabilities of the station, such as the ability of the station to participate in directional peer-to-peer communications. Neighbor discovery may be initiated and controlled by the serving device.

The station participates in directional service discovery (block 207). Directional service discovery may involve obtaining directional information regarding peer services and/or capabilities of stations located in close proximity (within range, peer to peer wise, of the station). The directional information is provided to the station by the serving device. Directional service discovery may be classified as either passive or active. In passive directional service discovery, the serving device includes the directional information in management frames, such as Beacon frames, transmitted by the serving device. The directional information is included in peer to station (peer-STA) information elements (IEs). In active directional service discovery, the station may send a request for the peer's directional information to the serving device and the serving device may send a response to the station including the peer's directional information. The response from the serving device may include peer-STA IEs. Directional service discovery may also be a combination of both passive and active where the serving device includes the peer's directional information in management frames.

FIG. 2B illustrates a flow diagram of example operations 230 occurring in passive directional service discovery. In passive directional service discovery, the serving device includes directional information (i.e., neighbor information about stations that are within range of the station or those served by the serving device) in management frames. The directional information may be placed in peer-STA IEs.

FIG. 2C illustrates a flow diagram of example operations 240 occurring in active directional service discovery. In active directional service discovery, the station requests the directional information from the serving device and the serving device responds with the requested directional information. The requested directional information may be included in peer-STA IEs.

FIG. 2D illustrates a flow diagram of example operations 250 occurring in passive and active directional service discovery. In passive and active directional service discovery, the serving device appends the requested directional information in management frames (block 255) and the station requests the peer's directional information from the serving device and the serving device responds with the requested peer's directional information (block 260). The requested directional information may be included in peer-STA IEs.

Referring back to FIG. 2A, the station performs a fast BF setup procedure (block 209). The fast BF setup procedure may involve the station obtaining geometry information from the serving device and determining (i.e., calculation, estimation, derivation, and so on) the angles of arrival for stations that are candidates for directional communications. The determination of the angles of arrival may be used in a first stage of a multi-stage approach to fast BF. A second stage of the multi-stage approach may involve a fine tuning of the transmission beams after a directional connection has been established. A detailed discussion of the fast BF setup procedure is provided below.

A check may be performed to determine if the directional connection has been established (block 211). If the directional connection has been established, the station performs directional communications with its peer(s) (block 215). If the directional connection has not been established, the station adjusts the beam pattern (block 213) and returns to repeat the fast BF setup procedure (block 209). Adjustments to the beam pattern may include changing the angle of arrival (or angle of departure), the width of the transmission beam, and so on. As an illustrative example, the station widens the width of the transmission beam by altering the antenna coefficients associated with the antennas of the station. As another illustrative example, the station changes the angle of arrival (or angle of departure), and changes the antenna coefficients associated with the changed angle of arrival (or angle of departure).

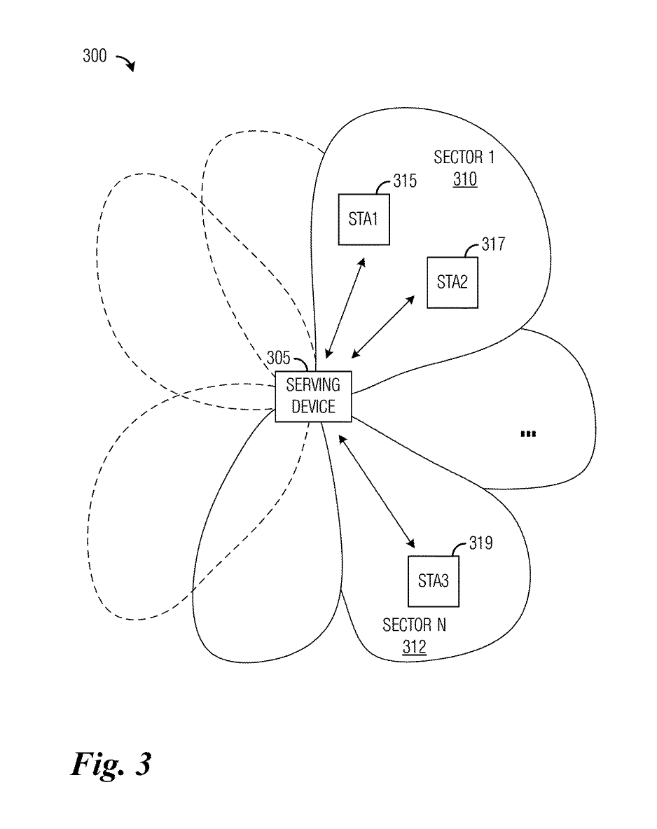

FIG. 3 illustrates a portion of a communications system 300 highlighting sectors of a coverage area of a serving device. Communications system 300 includes a serving device 305. Serving device 305 has a sectorized coverage area, including a plurality of sectors, such as sector 1 310, and sector N 312. Operating within the coverage area of serving device 305 includes a plurality of stations, including station 1 315, station 2 317 and station 3 319. Stations 1 315 and 2 317 are in close proximity to one another in sector 1 310, while station 3 319 is in sector N 312. Stations 1 315, 2 317, and 3 319 are communicating with serving device 305. Furthermore, some of the stations may be candidates for directional peer-to-peer communications.

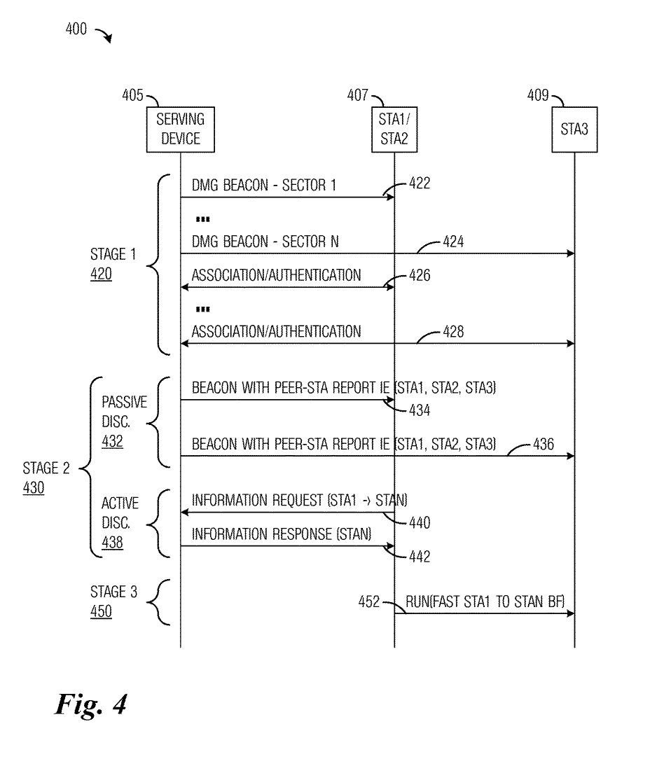

FIG. 4 illustrates a message exchange diagram 400 highlighting messages exchanged during the configuration of directional peer-to-peer communications. Message exchange diagram 400 displays messages exchanged between a serving device 405, a station 1/station 2 407, and a station 3 409. The configuration of directional peer-to-peer communications may take place in stages. In a first stage 420, the participants participate in an initialization procedure. The initialization procedure may involve serving device 405 sending Beacon frames in different sectors, such as a Beacon frame in sector 1 (shown as event 422) and a Beacon frame in sector N (shown as event 424). The Beacon frames may be beamformed so that they do not cause undue interference in neighboring sectors. Stations in the various sectors of the coverage area of serving device 405 and serving device 405 participate in an association and authentication procedure, such as station 1/station 2 407 and serving device 405 (shown as event 426) and station 3 409 and serving device 405 (shown as event 428).

In a second stage 430, the participants participate in a directional service discovery procedure. As discussed previously, directional service discovery may involve passive service discovery 432 or active service discovery 438 or both passive and active service discovery. Passive service discovery 432 may include serving device 405 sending Beacon frames with peer-STA IEs including information about the stations (such as stations 1/station 2 407 and station 3 409) (shown as events 434 and 436). Active service discovery 438 may include a station, such as one of stations 1/station 2 407 sending a request to serving device 405 (shown as event 440) and serving device 405 sending a response to the one of stations 1/station 2 407 (shown as event 442).

In a third stage 450, the participants participate in a fast BF setup procedure. As shown in FIG. 4, stations 1/station 2 407 and station 3 409 participate in the fast BF setup procedure (shown as event 452). As discussed previously, the fast BF setup procedure is a multi-stage procedure, where a station determines the angles of arrival of peer stations in accordance with geometry information of the peer stations provided by serving device 405 during second stage 430 to perform a quick initial stage of the fast BF setup procedure to establish a directional connection. The use of the angles of arrival in the quick initial stage of the fast BF setup procedure eliminates the station from having to perform a SLS beamforming scan, which can be time consuming if there is a large number of transmission beams. In a subsequent stage of the fast BF setup procedure, a fine tuning of the transmission beams is performed to improve directional performance.

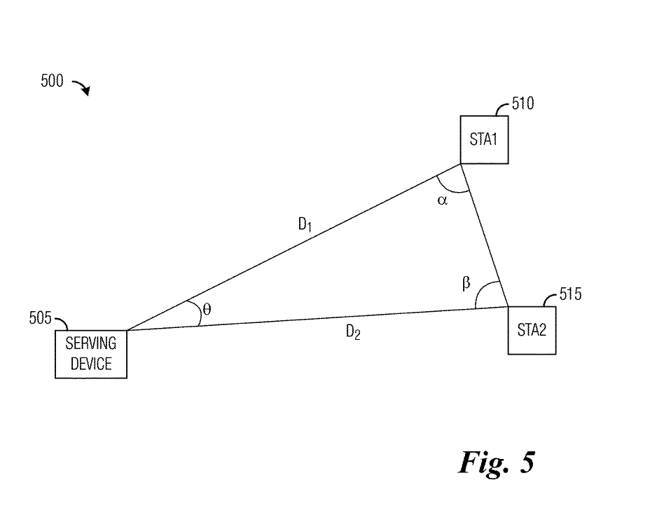

FIG. 5 illustrates a communications system 500 highlighting geometry information used in the fast BF setup procedure. Communications system 500 includes a serving device 505, a station 1 510, and a station 2 515. The geometry information applies to communications systems with greater numbers of serving devices and stations. Therefore, the illustration of a single serving device and two stations should not be construed as being limiting to either the scope or the spirit of the example embodiments.

Station 1 510 is a distance D₁ from serving device 505 and station 2 515 is a distance D₂ from serving device 505. An angle θ is the angle between lines from serving device 505 to station 1 510 and station 2 515. Similarly, an angle α is the angle between lines from station 1 510 to serving device 505 and station 2 515 and an angle β is the angle between lines from station 2 515 to serving device 505 and station 1 510. The angles α and β may be determined from known values, including θ, Gₜ—transmit antenna gain, Gᵣ—receive antenna gain, Pₜ—transmit power, Pᵣ—receiver sensitivity, λ—wavelength, Pₙₒᵢₛₑ—system noise power, SNR—signal to noise ratio, SINR—signal to interference plus noise ratio, k—Boltzmann's constant, Tₒ—system temperature, BW—system bandwidth, and NF—noise figure. The angles α and β are used to determine the angles of arrival for the stations. The known values may be provided to a station during the fast BF setup procedure (such as θ, Gₜ, Gᵣ, Pₜ, Pᵣ, Pₙₒᵢₛₑ, BW, and NF), stored in memory during manufacture or configuration (such as λ, and k), or read from sensors (such as Tₒ).

As an illustrative example, the angles α and β are derived as follows:
Derive a normalized distance d using Friis' transmission equation:

$$d = ( \frac{λ}{4 π} ) \sqrt{\frac{{P}_{t}}{{P}_{r}} {G}_{t} {G}_{r}} . \\ Since {P}_{r} = SNR \cdot {P}_{noise}$$

$$and$$

$${P}_{noise} = k \cdot {T}_{o} \cdot BW \cdot NF , \\ d is re \text{-} expected as \text{:}$$

$$d = ( \frac{λ}{4 π} ) \sqrt{\frac{{P}_{t}}{{P}_{noise} \cdot SNR} {G}_{t} {G}_{r}} .$$

The angle α is calculated as:

$$α = {sin}^{- 1} ( \frac{{D}_{2} sin θ}{\sqrt{{D}_{1}^{2} + {D}_{2}^{2} - 2 {D}_{1} {D}_{2} cos θ}} ) = {sin}^{- 1} ( \sqrt{\frac{SNR 1}{SNR 1 + SNR 2 - 2 cos θ \sqrt{SNR 1 \cdot SNR 2}}} \cdot sin θ ) ,$$

where SNR1 and SNR2 are the SNR at station 1 510 and station 2 515, respectively.
The angle β is calculated as:

$$β = {sin}^{- 1} ( \frac{{D}_{1} sin θ}{\sqrt{{D}_{1}^{2} + {D}_{2}^{2} - 2 {D}_{1} {D}_{2} cos θ}} ) = {sin}^{- 1} ( \sqrt{\frac{SNR 2}{SNR 1 + SNR 2 - 2 cos θ \sqrt{SNR 1 \cdot SNR 2}}} \cdot sin θ ) ,$$

where SNR1 and SNR2 are the SNRs of station 1 510 and station 2 515, respectively.
Additionally, only one of the two angles (α or β needs to be calculated using the expressions above due to the relationship of angles of a triangle that allows the other angle to be directly determined when two of the three angles of the triangle are known:

α=180−θ−β or β=180−θ−α.

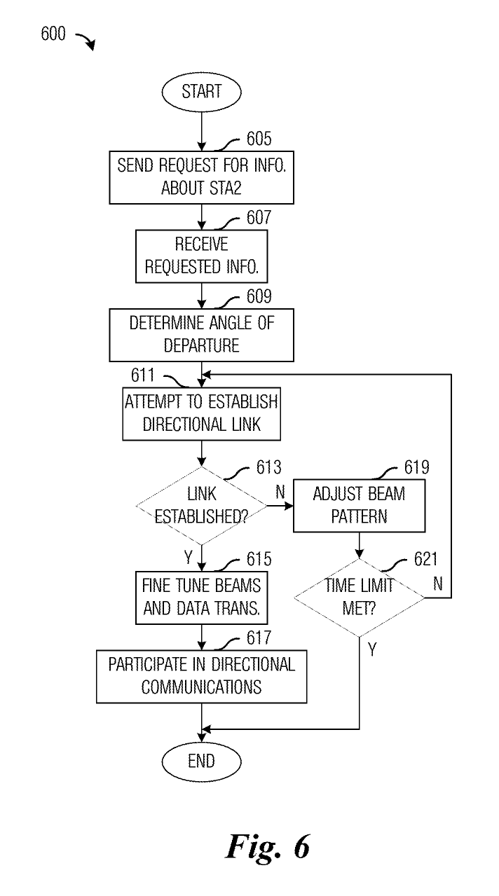

FIG. 6 illustrates a flow diagram of example operations 600 occurring in a station initiating directional communications using a multi-stage fast BF setup procedure as described herein. Operations 600 may be indicative of operations occurring in a first station as the station initiates directional communications with a second station using a multi-stage fast BF setup procedure.

Operations 600 begin with the first station sending a request for information about the second station (block 605). The request for information may be sent to a serving device. The information being requested includes geometry information that the first station uses to calculate the angle of arrival for the second station. The information being requested may also include information about services offered or supported by the second station, as well as the capabilities of the second station. The first station receives the requested information (block 607). The requested information includes the geometry information, including θ, Gₜ, Gᵣ, Pₜ, Pᵣ, Pₙₒᵢₛₑ, BW, and NF. The requested information may be received from the serving device.

The first station determines the angle of departure for the second station (block 609). As an illustrative example, the first station may use the expressions presented above to determine the angle of departure for the second station in accordance with the geometry information received from the serving device. The first station attempts to establish a directional link with the second station (block 611). As an illustrative example, the first station uses the angle of departure for the second station to generate a transmission beam (or select a transmission beam from a codebook of available transmission beams) to beamform a transmission to the second station and transmit the beamformed transmission to the second station. While the first station is determining the angle of departure for the second station and attempting to establish the directional link, the second station uses the angle of departure for the first station in order to receive the beamformed transmission transmitted from the first station by generating a reception beam oriented towards the first station or pointing its receive antenna at the first station.

The first station performs a check to determine if a directional link has been established between the first station and the second station (block 613). If the directional link has been established, the first station fine tunes transmission beams and data transmissions (block 615). The fine tuning of the transmission beams and data transmissions may improve the overall directional performance if the angle of departure for the second station (as determined by the first staion) is not sufficiently accurate and results in a transmission beam that is misaligned with respect to the second station. As an illustrative example, the first station adjusts the transmission beam (left or right, up or down, or a combination of left/right/up/down, for example), beamforms a transmission using the adjusted transmission beam, transmits the beamformed transmission, receives a report from the second station, and determines if the adjusted transmission beam resulted in improved or worsened performance. The fine tuning may be an iterative process and may continue until a performance threshold is met or a number of iterations threshold is met or a time limit is met. The first station and the second station participate in directional communications (block 617).

If the directional link has not been established, the first station adjusts the transmission beam pattern (block 619). Adjustments to the transmission beam pattern may include changing the angle of departure/arrival of the transmission beam, changing the beamwidth, and so on. The first station performs a check to determine if a time limit for performing fast station-to-station beamforming or a number of iterations limit has been met (block 621). If the limit has not been met, the first station returns to block 611 to attempt to establish a directional link with the second station. If the time limit has been met, operations 600 end without establishing a peer to peer link. Alternatively, instead of a time limit, a limit on a number of retries may be used to regulate the number of retries the first station performs.

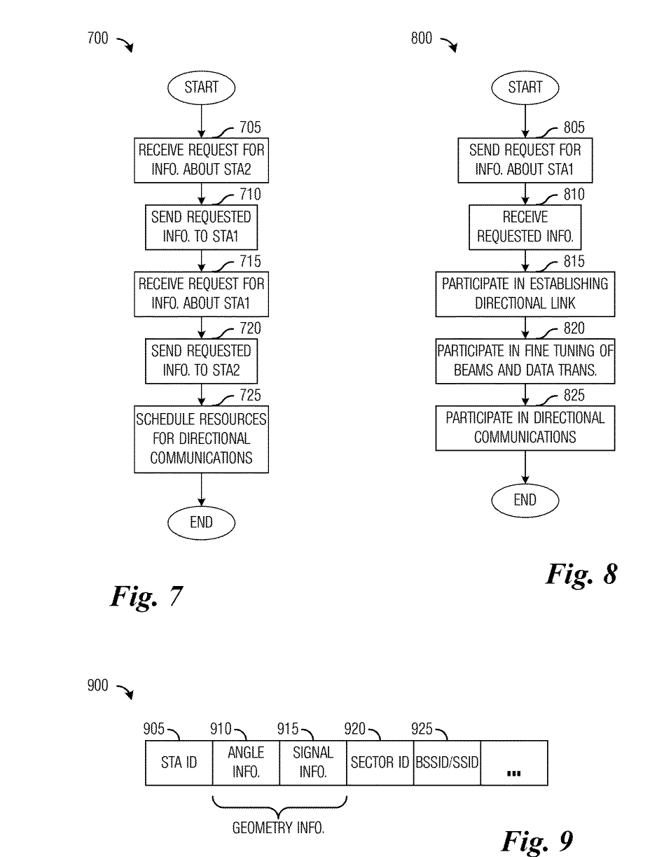

FIG. 7 illustrates a flow diagram of example operations 700 occurring in a serving device participating in a multi-stage fast BF setup procedure as described herein. Operations 700 may be indicative of operations occurring in a serving device participating in a multi-stage fast BF setup procedure.

Operations 700 begin with the serving device receiving a request for information about a second station from a first station (block 705). The information being requested includes geometry information that the first station uses to determine the angle of departure for the second station. The information being requested may also include information about services offered or supported by the second station, as well as the capabilities of the second station. The serving device sends the requested information to the first station (block 710). The serving device receives a request for information about the first station from the second station (block 715). The information being requested includes geometry information that the second station uses to determine the angle of arrival for the first station. The information being requested may also include information about services offered or supported by the first station, as well as the capabilities of the first station. The serving device sends the requested information to the second station (block 720). The serving device may schedule communications system resources for directional communications (block 725). The serving device may schedule communications system resources in the form of a service period (SP) or a contention-based access period (CBAP) for station-to-station communications.

FIG. 8 illustrates a flow diagram of example operations 800 occurring in a station participating in directional peer to peer communications involving a multi-stage fast BF setup procedure as described herein. Operations 800 may be indicative of operations occurring in a second station participating in directional peer-to-peer communications involving a multi-stage fast BF setup procedure with a first station.

Operations 800 begin with the second station sending a request for information about the first station (block 805). The request for information may be sent to a serving device. The information being requested includes geometry information that the second station uses to calculate the angle of arrival for the first station. The information being requested may also include information about services offered or supported by the first station, as well as the capabilities of the first station. The second station receives the requested information (block 810). The second station participates in an establishing of a directional link with the first station (block 815). Participating in the establishing of a directional link may involve the second station receiving a beamformed transmission from the first station and responding to the beamformed transmission. The beamformed transmission may initiate the directional link and the response to the beamformed transmission may establish the directional link. The second station may, for example, determine an angle of departure for the first station in accordance with the received information and use the angle of departure to generate a reception beam oriented towards the first station. Alternatively, the second station may orient its receive antenna towards the first station in accordance with the angle of departure for the first station. The second station participates in fine tuning the transmission beams and data transmissions (block 820). Participating in the fine tuning may include the second station receiving a beamformed transmission from the first station, where the beamformed transmission has been beamformed with a transmission beam that is different from the one used in establishing the directional link. As an illustrative example, the transmission beam may be based on an adjusted angle of departure for the second station. The second station may respond with an indicator of the measurement of the beamformed transmission. The fine tuning process may be an iterative process where the second station receives multiple beamformed transmissions and responds with multiple indicators of the measurement of the beamformed transmission. The second station participates in directional communications with the first station (block 825).

FIG. 9 illustrates an example peer-STA IE 900. Peer-STA 900 includes, amongst other fields: a station identifier (STA ID) field 905 that contains an identifier, such as a media access control (MAC) address, of a station; an angle information field 910 that contains angle of arrival information for the station (there may be multiple angle information fields, one field per angle); a signal information field 915 that contains signal information for the station relative to the serving device, such as SNR, SINR, and so on; a sector identifier (SECTOR ID) field 920 that contains an identifier of a sector where the station is located, a basic service set identifier (BSSID) or service set identifier (SSID) field 925 that contains an identifier of a BSS or SS of the personal basic service set (PBSS).

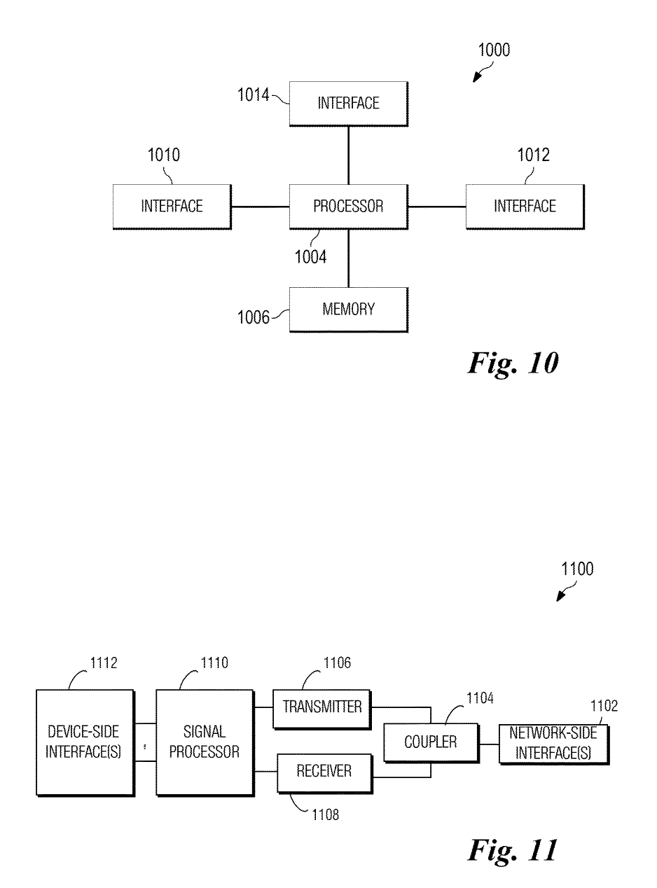

FIG. 10 illustrates a block diagram of an embodiment processing system 1000 for performing methods described herein, which may be installed in a host device. As shown, the processing system 1000 includes a processor 1004, a memory 1006, and interfaces 1010-1014, which may (or may not) be arranged as shown in FIG. 10. The processor 1004 may be any component or collection of components adapted to perform computations and/or other processing related tasks, and the memory 1006 may be any component or collection of components adapted to store programming and/or instructions for execution by the processor 1004. In an embodiment, the memory 1006 includes a non-transitory computer readable medium. The interfaces 1010, 1012, 1014 may be any component or collection of components that allow the processing system 1000 to communicate with other devices/components and/or a user. For example, one or more of the interfaces 1010, 1012, 1014 may be adapted to communicate data, control, or management messages from the processor 1004 to applications installed on the host device and/or a remote device. As another example, one or more of the interfaces 1010, 1012, 1014 may be adapted to allow a user or user device (e.g., personal computer (PC), etc.) to interact/communicate with the processing system 1000. The processing system 1000 may include additional components not depicted in FIG. 10, such as long term storage (e.g., non-volatile memory, etc.).

In some embodiments, the processing system 1000 is included in a network device that is accessing, or part otherwise of, a telecommunications network. In one example, the processing system 1000 is in a network-side device in a wireless or wireline telecommunications network, such as a base station, a relay station, a scheduler, a controller, a gateway, a router, an applications server, or any other device in the telecommunications network. In other embodiments, the processing system 1000 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1010, 1012, 1014 connects the processing system 1000 to a transceiver adapted to transmit and receive signaling over the telecommunications network. FIG. 11 illustrates a block diagram of a transceiver 1100 adapted to transmit and receive signaling over a telecommunications network. The transceiver 1100 may be installed in a host device. As shown, the transceiver 1100 comprises a network-side interface 1102, a coupler 1104, a transmitter 1106, a receiver 1108, a signal processor 1110, and a device-side interface 1112. The network-side interface 1102 may include any component or collection of components adapted to transmit or receive signaling over a wireless or wireline telecommunications network. The coupler 1104 may include any component or collection of components adapted to facilitate bi-directional communication over the network-side interface 1102. The transmitter 1106 may include any component or collection of components (e.g., up-converter, power amplifier, etc.) adapted to convert a baseband signal into a modulated carrier signal suitable for transmission over the network-side interface 1102. The receiver 1108 may include any component or collection of components (e.g., down-converter, low noise amplifier, etc.) adapted to convert a carrier signal received over the network-side interface 1102 into a baseband signal. The signal processor 1110 may include any component or collection of components adapted to convert a baseband signal into a data signal suitable for communication over the device-side interface(s) 1112, or vice-versa. The device-side interface(s) 1112 may include any component or collection of components adapted to communicate data-signals between the signal processor 1110 and components within the host device (e.g., the processing system 1000, local area network (LAN) ports, etc.).

The transceiver 1100 may transmit and receive signaling over any type of communications medium. In some embodiments, the transceiver 1100 transmits and receives signaling over a wireless medium. For example, the transceiver 1100 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1102 comprises one or more antenna/radiating elements. For example, the network-side interface 1102 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1100 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

Although the present disclosure and its advantages have been described in detail, it should be understood that various changes, substitutions and alterations can be made herein without departing from the spirit and scope of the disclosure as defined by the appended claims.

What is claimed is:

1. A method for operating a first station adapted for directional peer-to-peer communications, the method comprising:
obtaining, by the first station, geometry information associated with a second station; and
establishing, by the first station, a directional peer-to-peer link with the second station with a first transmission beamformed in accordance with an angle of departure for the second station, wherein the angle of departure is associated with the geometry information.

2. The method of claim 1, further comprising:
adjusting, by the first station, the angle of departure for the second station to improve the directional peer-to-peer link;
beamforming, by the first station, a second transmission in accordance with the adjusted angle of departure for the second station; and
sending, by the first station, the beamformed second transmission.

3. The method of claim 1, wherein obtaining, by the first station, the geometry information comprises:
sending, by the first station, a request for the geometry information to a serving device serving the first station and the second station; and
receiving, by the first station, the geometry information from the serving device.

4. The method of claim 1, further comprising:
performing, by the first station, a directional service discovery procedure with a serving device serving the first station and the second station.

5. The method of claim 4, wherein performing, by the first station, the directional service discovery procedure comprises performing, by the first station, at least one of a passive directional service discovery procedure and an active directional service discovery procedure.

6. The method of claim 5, wherein performing, by the first station, the passive directional service discovery procedure comprises:
receiving, by the first station, a Beacon frame including at least one peer to station (peer-STA) information element (IE) from the serving device.

7. The method of claim 5, wherein performing, by the first station, the active directional service discovery procedure comprises:
sending, by the first station, an information request to a serving device; and
receiving, by the first station, an information response from the serving device.

8. The method of claim 1, further comprising determining, by the first station, the angle of departure for the second station comprises:
evaluating
$$β = {sin}^{- 1} ( \frac{{D}_{1} sin θ}{\sqrt{{D}_{1}^{2} + {D}_{2}^{2} - 2 {D}_{1} {D}_{2} cos θ}} ) = {sin}^{- 1} ( \sqrt{\frac{SNR 2}{SNR 1 + SNR 2 - 2 cos θ \sqrt{SNR 1 \cdot SNR 2}}} \cdot sin θ ) ,$$
where θ is an angle between lines originating from a serving device and ending at the first station and the second station, α is an angle between a first line from the first station to the serving device and a second line from the first station to the second station, β is an angle between a third line from the first station to the serving device and a fourth line from the second station to the first station, D₁ is a distance from the serving device to the first station, D₂ is a distance from the serving device to the second station, SNR1 is a signal to noise ratio of the first station, and SNR2 is a signal to noise ratio of the second station.

9. The method of claim 1, wherein establishing, by the first station, the directional peer-to-peer link comprises:
beamforming, by the first station, the first transmission with a transmission beam selected in accordance with the angle of departure for the second station;
sending, by the first station, the beamformed first transmission; and
receiving, by the first station, a response from the second station.

10. The method of claim 1, wherein establishing, by the first station, the directional peer-to-peer link comprises:
receiving, by the first station, the first transmission beamformed with a transmission beam selected in accordance with the angle of departure of the first station; and
sending, by the first station, a response to the second station.

11. The method of claim 1, further comprising:
receiving, by the first station, a second transmission beamformed with a transmission beam selected in accordance with an adjusted angle of departure of the first station; and
sending, by the first station, a response to the second transmission to the second station.

12. A method for operating a serving device, the method comprising:
providing, by the serving device, first geometry information associated with a first station to a second station responsive to a first request from the second station;
providing, by the serving device, second geometry information associated with the second station to the first station responsive to a second request from the first station; and
scheduling, by the serving device, resources for directional communications between the first station and the second station.

13. The method of claim 12, wherein the first and second geometry information are included in peer to station (peer-STA) information elements (IEs).

14. The method of claim 12, wherein the first and second geometry information comprise θ, Gₜ, Gᵣ, Pₜ, Pᵣ, Pₙₒᵢₛₑ, BW, and NF, where θ is an angle between lines originating from the serving device and ending at the first station and the second station, Gₜ is a transmit antenna gain, Gᵣ is a receive antenna gain, Pₜ is a transmit power, Pᵣ is a receiver sensitivity, Pₙₒᵢₛₑ is a system noise power of a communications system including the serving device and the first and second stations, BW is a system bandwidth of the communications system, and NF is a noise figure of the communications system.

15. The method of claim 12, wherein scheduling, by the serving device, the resources comprises scheduling, by the serving device, time and frequency resources for the directional communications.

16. A first station adapted for directional communications, the first station comprising:
a processor; and
a computer readable storage medium storing programming for execution by the processor, the programming including instructions to configure the first station to:
obtain geometry information associated with a second station, and
establish a directional peer-to-peer link with the second station using a first transmission beamformed in accordance with an angle of departure for the second station, wherein the angle of departure is associated with the geometry information.

17. The first station of claim 16, wherein the programming includes instructions to adjust the angle of departure for the second station to improve the directional peer-to-peer link, to beamform a second transmission in accordance with the adjusted angle of departure for the second station, and to send the beamformed second transmission.

18. The first station of claim 16, wherein the programming includes instructions to send a request for the geometry information to a serving device serving the first station and the second station, and to receive the geometry information from the serving device.

19. The first station of claim 16, wherein the programming includes instructions to perform a directional service discovery procedure with a serving device serving the first station and the second station.

20. The first station of claim 16, wherein the programming includes instructions to determine the angle of departure for the second station by evaluating
$$β = {sin}^{- 1} ( \frac{{D}_{1} sin θ}{\sqrt{{D}_{1}^{2} + {D}_{2}^{2} - 2 {D}_{1} {D}_{2} cos θ}} ) = {sin}^{- 1} ( \sqrt{\frac{SNR 2}{SNR 1 + SNR 2 - 2 cos θ \sqrt{SNR 1 \cdot SNR 2}}} \cdot sin θ ) ,$$
where θ is an angle between lines originating from a serving device and ending at the first station and the second station, α is an angle between a first line from the first station to the serving device and a second line from the first station to the second station, β is an angle between a third line from the first station to the serving device and a fourth line from the second station to the first station, D₁ is a distance from the serving device to the first station, D₂ is a distance from the serving device to the second station, SNR1 is a signal to noise ratio of the first station, and SNR2 is a signal to noise ratio of the second station.

21. The first station of claim 16, wherein the programming includes instructions to beamform the first transmission with a transmission beam selected in accordance with the angle of departure for the second station, to send the beamformed first transmission, and to receive a response from the second station.

22. The first station of claim 16, wherein the programming includes instructions to receive the first transmission beamformed with a transmission beam selected in accordance with the angle of departure of the first station, and to send a response to the second station.

23. The first station of claim 16, wherein the programming includes instructions to receive a second transmission beamformed with a transmission beam selected in accordance with an adjusted angle of departure of the first station, and send a response to the second transmission to the second station.

24. A serving device adapted for directional communications, the serving device comprising:
a processor; and
a computer readable storage medium storing programming for execution by the processor, the programming including instructions to configure the serving device to:
provide first geometry information associated with a first station to a second station responsive to a first request from the second station,
provide second geometry information associated with the second station to the first station responsive to a second request from the first station, and
schedule resources for directional communications between the first station and the second station.

25. The serving device of claim 24, wherein the programming includes instructions to schedule time and frequency resources for the directional communications.

26. The serving device of claim 24, wherein the first and second geometry information comprise θ, Gₜ, Gᵣ, Pₜ, Pᵣ, Pₙₒᵢₛₑ, BW, and NF, where θ is an angle between lines originating from the serving device and ending at the first station and the second station, Gₜ is a transmit antenna gain, Gᵣ is a receive antenna gain, Pₜ is a transmit power, Pᵣ is a receiver sensitivity, Pₙₒᵢₛₑ is a system noise power of a communications system including the serving device and the first and second stations, BW is a system bandwidth of the communications system, and NF is a noise figure of the communications system.
